(19) United States
(12) Patent Application Publication
(10) Pub. No.: US 2002/0087399 A1
(43) Pub. Date: Jul. 4, 2002

(54) Sales promotion method of merchandise

(76) Inventor: Kazunori Sudo, Kawasaki-shi (JP)

Correspondence Address: REED SMITH HAZEL & THOMAS LLP, Suite 1400, 3110 Fairview Park Drive, Falls Church, VA, 22042, US

(21) Appl. No.: 09/750,141

(22) Filed: Dec. 29, 2000

(51) Int. Cl. G06F 17/60

(52) U.S. Cl. 705/14; 705/26; 705/27

(57) ABSTRACT

Information regarding which kind of product consumers want to buy can be easily provided from a plurality of consumers.

The method comprises: a step of making an entry of a plurality of sales promotion merchandise; a video server and or data server that can monitor the entered sales promotion merchandise, respectively; a step of extracting a certain amount of a single merchandise, such as predetermined video data, audio data or other character data, from the both servers and inputting this to the same recording medium; a step of distributing the recording medium to a plurality of monitors; a step of collecting questionnaires from the monitors; and a step of summing up and evaluating the questionnaires.

### BACKGROUND OF THE INVENTION

1. Field of the Invention

The present invention relates to a sales promotion method of music such as popular songs, publications, game software or the like.

2. Related art

For example, when a new song is released, and sales promotion of “CD” of that song is executed, campaign is organized in record shops nationwide, or as the sales promotion of a new cartoon magazine or monthly publications, or various software games, only such a measure is taken as placing these in a prominent place to customers in the bookstore or game software shops.

However, from consumers, customers or fans, it is desired that they can listen to the “beginning” or “climax portion+, or if possible, only the first part of a plurality of newly released songs sequentially, to confirm the quality, while comparing these songs, to thereby decide which song to be purchased.

Moreover, in the similar manner, it is wonderful if they can purchase a newly published book or game software, which they want to buy the most, in comparison with others.

As described above, for production of CDs, books or game software or for distributors thereof, it is certain that the important element in the sales policy, sales promotion and production planning in order to sell such merchandise is to grasp the needs of customers.

### SUMMARY OF THE INVENTION

It is, therefore, an object of the present invention to make it possible to easily obtain the information regarding which kind of product consumers want to buy, from a plurality of consumers, and to make use of this information for sales promotion of the concerned merchandise.

That is to say, the present invention is characterized by comprising: a step of making an entry of a plurality of sales promotion merchandise; a video server and or data server that can monitor the entered sales promotion merchandise, respectively; a step of extracting a certain amount of a single merchandise, such as predetermined video data, audio data or other character data, from the both servers and inputting this to the same recording medium; a step of distributing the recording medium to a plurality of monitors; a step of collecting questionnaires from the monitors; and a step of summing up and evaluating the questionnaires, so that the evaluation can be provided to consumers.

Then, a song, a book or game software, at least the “climax” portion thereof is taken out by genre, and input to respective servers together with the image of the singer's face of that song or image of other characters, and information of the birthday and profiles of the singer, so that a desired set of these pictures and data that agrees with the picture is output to a recording medium such as DVD.

Theses recording media are also characterized in that, in general, a so-called commercial by the sponsor is inserted between the plurality of songs in most cases. As a result, these recording media such as CD or DVD for sales promotion can be distributed to the general public free of charge.

Thereafter, questionnaires regarding “which is the best song”, “whose looks is the best”, “which do you want to buy” or the like are collected from the person who received the recording medium. If necessary, in case of songs, a weight is decided in advance, for example, a skill as a singer is 50% with respect to the overall evaluation, and looks is 20% , etc., and evaluation is made based on the weight. As a result, it becomes clear which song, which book, or which game software is most desired by consumers, to thereby provide important information for sales promotion.

Moreover, it becomes possible, with regard to the plurality of street musicians, to produce and distribute the similar recording medium, to thereby find a new figure who can be expected in the future, or to provide the result of the above-described questionnaires to a record company and ask for economical support, such as becoming a sponsor.

The effects of the present invention are as described below:

1. In the case of songs, books or computer game software, it is possible to provide excellent information of what type will become popular, will be accepted by consumers, that is, will be best sold in the future, at high probability. That is to say, different from the conventional musical CD sales methods, a proprietary sales method (sales based on a market research with respect to general audience) is taken, thereby enabling reduction of wasteful sales expenses.

2. It is possible to find new figures who have been unrecognized in the field and send them into the world.

3. In the case of songs, since general users can listen to songs of various musicians free of charge, regardless of the genre, support from general users can be easily obtained. Therefore, the possibility of making their debut speedily from amateurs to professionals increases. In addition, the number of monitors increases, enabling sales of CD based on the information of popularity, well selling degree or the like.

4. Since CM is inserted between songs, users have to listen to the CM. In addition, due to the questionnaire format, users listen to the CD repeatedly, and every time, users listen to the CM at the same time. Therefore, the effect thereof is limitless. Moreover, advertisement that is transferred by way of mouth of navigators is also possible.

In the present invention, in particular, the description is for new songs and new music, but the present invention is not limited thereto, and the application range is very wide, which will become clear in the embodiment described below.

### BRIEF DESCRIPTION OF THE DRAWINGS

FIG. 1 is an overall block diagram for executing the present invention.

FIG. 2 is production flowchart of a recording medium for distribution.

### DESCRIPTION OF THE PREFERRED EMBODIMENTS

The embodiment of the present invention will be described for a case of a release of a so-called hit song, sales promotion or scouting of a new figure. At first, information regarding an image of a so-called new song and the singer thereof, and the profile of the concerned singer is obtained.

The acquisition of these information is relatively easy. That is to say, these information can be provided easily by regular visit to music promotion offices and record companies, because “the new song can be advertised”. With regard to scouting of a new figure, a plurality of so-called street musicians may be invited.

As for the recording medium distributed in this embodiment, CD (compact disk) is used. This is because input of image and various data is easy, the production cost is inexpensive, and most people such as persons to be distributed (monitors) have a CD player.

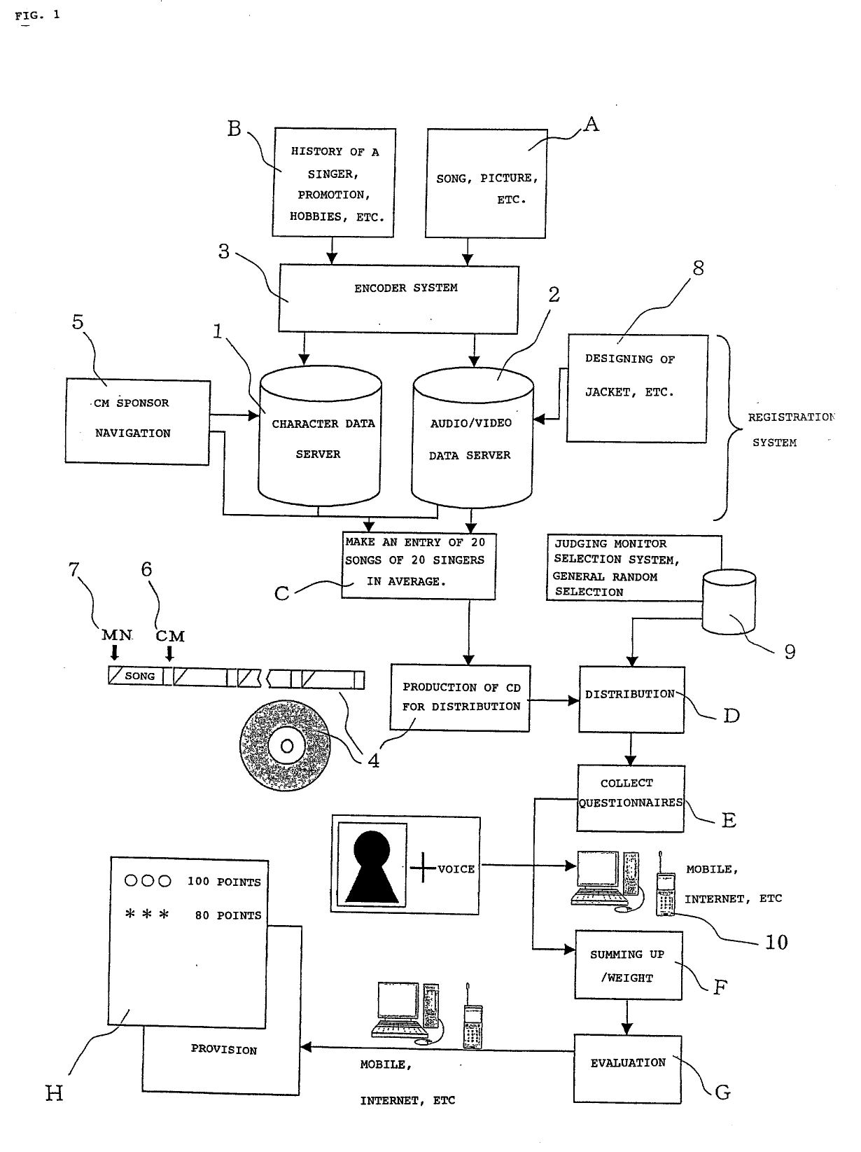

FIG. 1 is a block diagram for executing the present invention, wherein reference symbol (1) denotes a character data server, (2) denotes a video or audio image server. A plurality of new songs, songs by new singers and pictures (A), as well as character data (B) such as profile of those singers are input to respective servers (1), (2), using terminal means (not shown). At this time, it is important that the information input to respective servers (1), (2) is encoded in an encoding system (3), so that a key word that becomes a key at the time of output of the information is added.

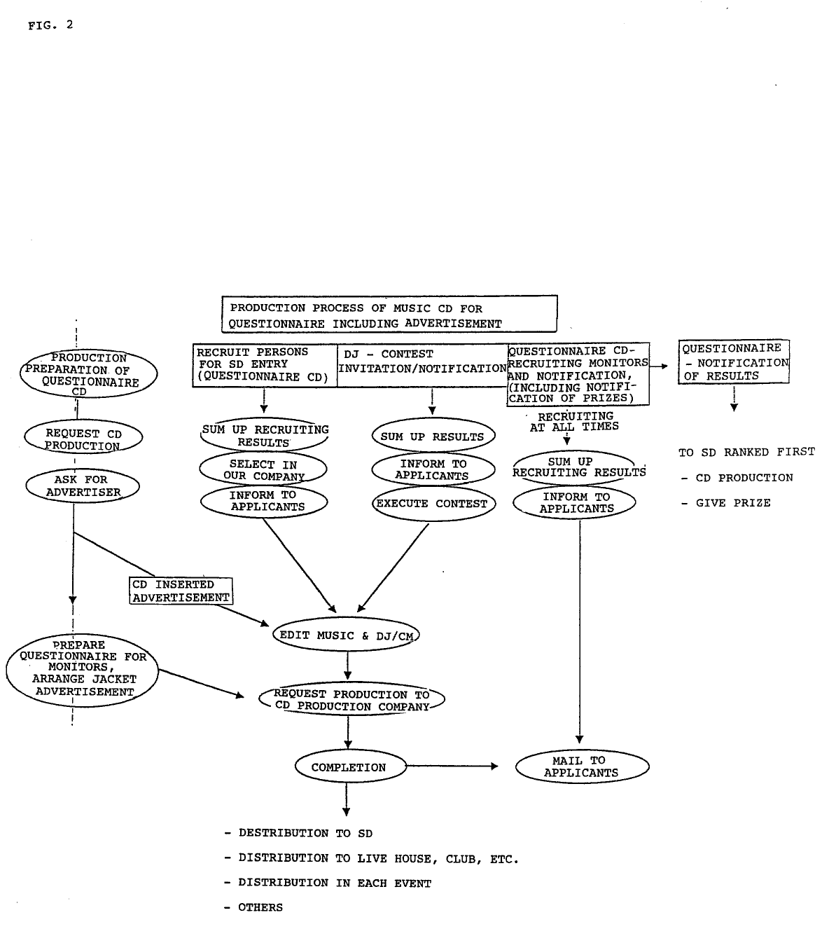

The next operation is to produce a recording medium (4) such as CD for distribution to monitors, as shown in FIG. 2. That is to say, the above-described video server (2) is searched, to thereby select (C) about 20 songs and pictures. Thereafter, among the selected songs and pictures, at least parts which are desired to appeal to consumers are arranged and input. In this case, input of about 20 songs per one CD is adequate in view of capacity, for monitors, to whom the CD is distributed, to listen all songs input in the CD and compare these and put ranking.

At the time of production of the recording medium (4) for distribution to monitors, it may rely on the advertising expenses of the sponsor. In this case, a commercial message <CM>5 for the sponsor's merchandise is stored on the data server (1) and or video server (2), as shown in the figure. Then, at the time of production of the recording medium (4) for distribution, commercial (6) or the like is input between the entered songs and pictures. Moreover, at the “beginning” portion of each entered song or picture, navigation (7) for introducing the music and profile of the singer may be input by a disc jockey <DJ> or the like.

Moreover, at the time of distribution of the recording medium 4 such as CD, in which the above-described songs are input, the existence of a so-called jacket (8), being an enclosure, cannot be ignored. Therefore, the concerned jacket (8) is stored in the video server (2), and it is important to display the jacket (8) related to the song, corresponding to the song.

This recording medium (4) may be distributed to the general public on the “street”, however, it had better input in a system server (9) that can choose many and unspecified people, age, sex, address (residence), and genre of favorite music of these people, in advance, and distribute the CD free of charge (D) to a proper number of people based on the input.

This is because, as a matter of course, monitors respect themselves that they have been chosen among others, and reasonably respond to the questionnaire, and therefore it is possible to know in which area and in which age group the song is liked.

The results are obtained by collecting the questionnaires (E), and summing up by a personal computer (10), and evaluation (G) including the weight (F) can be output. In this case, it is a matter of course that if an award is given to the questionnaire, the rate of collection increases. Here, the weight (F) is chosen, like “a skill as a singer is 50 points”, and “looks is 20 points”, etc., and singers are arranged in the order of the most excellent in the composite score, with a brief review being given, to thereby complete the final evaluation table (H).

Moreover, this evaluation table (H) is not limited to a hard copy, and may be one using a PC terminal or a network line such as mobile communication.

This evaluation table (H) is sold onerously to record companies and many promotion companies. Such an evaluation table becomes the best information source for planning the future sales policy, such as which song is best accepted to consumers, that is, is best linked to the sales, among newly released songs, and people in which area and in which age group like the song.

In the embodiment of the present invention, “new song” has been mainly described. However, the present invention is not limited thereto, and in the case of sales promotion of game software, characters and action scenes are input to the video server, to perform the above-described operation. In other cases, the present invention can be applied to a “new book”, or input information can be changed, thereby enabling application even to diagnosis, correction or guidance of foot, back, etc.

What is claimed is:

1. A sales promotion method of merchandise comprising:
a step of making entries of a plurality of sales promotion merchandise;
a video server and/or data server that can monitor said entered sales promotion merchandise, respectively;
a step of extracting a certain amount of a single merchandise, such as predetermined video data, audio data or other character data, from the both servers and inputting this to the same recording medium;
a step of distributing said recording medium to a plurality of monitors;
a step of collecting questionnaires from the monitors; and
a step of summing up and evaluating the questionnaires, so that said evaluation can be provided to consumers.

2. A sales promotion method of merchandise according to claim 1, wherein a commercial by a sponsor such as a producer of said merchandise is input between the single merchandises input in said recording medium.

3. A sales promotion method of merchandise according to claim 1 or 2, wherein in addition to the contents of said sales promotion merchandise, a guidance of said merchandise is input in the video server and or data server.

4. A sales promotion method of merchandise according to any one of claims 1 to 3, wherein said sales promotion merchandise includes a plurality of products selected from fields of music such as popular songs, books including cartoons, periodical literature such as monthly publication and weekly magazine, and game software.

5. A sales promotion method of merchandise according to any one of claims 1 to 4, wherein the image in said video server is composed of a motion picture and or static image.
